(19) United States
(12) Patent Application Publication
(10) Pub. No.: US 2009/0278956 A1
(43) Pub. Date: Nov. 12, 2009

(54) METHOD OF DETERMINING PRIORITY ATTRIBUTES ASSOCIATED WITH DATA CONTAINERS, FOR EXAMPLE IN A VIDEO STREAM, A CODING METHOD, A COMPUTER PROGRAM AND ASSOCIATED DEVICES

(75) Inventors: Fabrice Le Leannec, Mouaze (FR); Patrice Onno, Rennes (FR); Xavier Henocq, Melesse (FR)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/435,730

(22) Filed: May 5, 2009

(30) Foreign Application Priority Data
May 7, 2008 (FR) 0853041

(51) Int. Cl. H04N 5/228; G06K 9/36

(52) U.S. Cl. 348/222.1; 382/233; 348/E05.024

(57) ABSTRACT

A method of determining priority attributes respectively associated with a plurality of containers defining at least one image at a plurality of spatial resolution levels comprises the following steps:
for at least two distinct spatial resolution levels considered, selecting at least one container (L₁, L₂; L₁, I₁) relative to a level lower than the level considered so as to optimize a rate-distortion criterion obtained by the use, for the decoding of the image at the level considered, of only the containers (L₁, L₂; L₁, I₁) selected as data relative to said lower level;
associating with each of the selected containers (L₁, I₁, L₂) an attribute representing a priority increasing with the maximum level for which the container is selected.

A coding method, devices and computer program that are associated therewith are also provided.

This application claims a priority from French patent application No. 0853041 of May 7, 2008 which is incorporated herein by reference.

### FIELD OF THE INVENTION

The invention concerns a method of determining priority attributes associated with data containers, for example in a video stream, as well as a coding method, a computer program and associated devices.

### BACKGROUND OF THE INVENTION

In the field of the coding and the transmission of images or sequences of images representing a video, it is known to represent the images at different levels of quality and spatial resolution (as well as at different temporal resolution levels in the case of an image sequence) in particular in order to transmit a version of the image or of the image sequence that is adapted (for example in real time) to the bandwidth of the transmission channel.

In this context, the images of higher quality or of better resolution (spatial or temporal) are generally defined by refinement data (sometimes termed enhancement data, or improvement data) which enable the image at that higher resolution or quality to be retrieved starting with representations of lower quality or resolution received beforehand. It is thus provided to arrange the data to transmit in order so as to communicate, first of all, the data that most reduces the distortion of the image (or images) transmitted for a given rate.

It is thus provided, for example according to the SVC standard, to place the data representing, for the same spatial resolution, the different quality levels of the pictures of a group of pictures in containers (termed “NAL units” under that standard) which are arranged in order by means of a priority attribute.

The different containers thus define different quality layers, also termed priority layers, arranged in order, and the extraction of data for them to be transmitted may then simply be limited to the higher priority layers that it is possible to transmit with the available bandwidth over the transmission channel.

When such priority layers are defined separately for each spatial resolution level as in the case mentioned above, the highest priorities have conventionally been assigned to the priority layers defining the lowest spatial resolution level and a decreasing priority with increasing spatial resolution level, with the idea that it was preferable to obtain all the data relative to a specific spatial resolution level before receiving refinement data relative to a higher spatial resolution level.

It has however been noted that such a manner of proceeding may not be optimum (in terms of a rate-distortion compromise) on transmission and decoding of the higher resolution level since the last priority layers relative to the lower spatial resolution could prove less effective in reducing the distortion than the first quality layers of the higher resolution level.

On account of this, it has been proposed, for example in the document WO 2007/111 460, to arrange the containers in order no longer separately by spatial resolution level, but by considering all the spatial resolution levels and by optimizing a rate-distortion criterion in this context.

This solution however only optimizes that rate-distortion criterion for the higher resolution level, and not for the intermediate spatial resolution levels for which the arrangement in order by means of priority attributes determined in the context of the higher spatial resolution level is not necessarily optimum.

### SUMMARY OF THE INVENTION

In this context, the invention provides a method of determining priority attributes respectively associated with a plurality of containers defining at least one image at a plurality of spatial resolution levels, characterized in that it comprises the following steps:
for at least two distinct spatial resolution levels considered, selecting at least one container relative to a level lower than the level considered so as to optimize a rate-distortion criterion obtained by the use, for the decoding of the image at the level considered, of only the containers selected as data relative to said lower level;
associating with each of the selected containers an attribute representing a priority increasing with the maximum level for which the container is selected.

The choice between continuing with the definition of a spatial resolution level and defining the level immediately above is thus carried out in optimized manner for each spatial resolution level, which makes it possible to optimize the rate-distortion criterion on reconstruction (that is to say on decoding) whatever the spatial resolution level used.

The selection is for example carried out within a step comprising the allocation of a temporary priority attribute to each of the containers of the level considered.

The selection may then be carried out on the basis of the temporary priority attributes allocated beforehand to the selected containers of the lower level, that is to say keeping the order of the containers such as was determined at the step of allocating priority attributes relative to the lower spatial resolution level.

As a variant, said step may also comprise the allocation of a temporary priority attribute to each of the selected containers of the lower level, that is to say without taking into account the priority attribute which was allocated to them beforehand. Only the non-selected containers in this case keep the attribute which was allocated to them at the step of allocating priority attributes relative to the lower spatial resolution level.

In these different cases in which a temporary attribute is used, the step of associating an attribute (which may be qualified as “definitive” for the method studied here) with a selected container comprises for example determining said attribute on the basis of said temporary attribute and of the maximum level for which the container is selected, which makes it possible to keep the specific order determined by the allocating steps referred to above while taking into account the value of the container for the decoding of the higher resolution levels.

In practice, the method comprises for example iterations each corresponding to a spatial resolution level and thus going through the resolution levels in decreasing order, and the associating step may then be carried out at the first iteration at which the container is selected for the resolution level corresponding to the iteration, which makes it possible to perform the association provided above in a simple manner.

Furthermore, the selection for a given spatial resolution level is, according to the embodiment provided, carried out from the containers selected for the spatial resolution level immediately below said given level, which makes it possible to have a number of containers that is at least stable or even decreasing with the spatial resolution level considered.

According to a particular application, the plurality of containers may define a plurality of images of a video stream.

The invention also provides a method of coding at least one image into a data stream comprising a plurality of containers, characterized in that it comprises the following steps:
determining priority attributes associated with said containers according to a method as presented above;
writing the determined priority attributes in the data stream.

The priority attribute associated with a container is for example written in a header field of said container.

The invention thus provides in particular a method of determining priority attributes respectively associated with a plurality of containers defining at least one image at a plurality of spatial resolution levels comprising at least one low level, an intermediate level and a high level, characterized in that it comprises:
a first step of selecting at least one container relative to a first level lower than the intermediate level so as to optimize a rate-distortion criterion obtained by the use, for the decoding of the image at the intermediate level, of only the containers selected as data relative to the first lower level;
a second step of selecting at least one container relative to a second level lower than the high level so as to optimize a rate-distortion criterion obtained by the use, for the decoding of the image at the high level, of only the containers selected as data relative to the second lower level;
associating with each of the containers selected at the first selecting step and not selected at the second selecting step an attribute representing a lower priority than those associated with the containers selected at the second selecting step and higher than those associated with the containers not selected at the first selecting step.

The invention also provides a computer program loadable into a computer system, said program containing instructions enabling the implementation of one of the methods referred to above, when that program is loaded and executed by the computer system.

The invention furthermore provides a device for determining priority attributes respectively associated with a plurality of containers defining at least one image at a plurality of spatial resolution levels, characterized in that it comprises means for selecting, for at least two distinct spatial resolution levels considered, at least one container relative to a level lower than the level considered so as to optimize a rate-distortion criterion obtained by the use, for the decoding of the image at the level considered, of only the containers selected as data relative to said lower level and means for associating with each of the selected containers an attribute representing a priority increasing with the maximum level for which the container is selected.

This device may optionally comprise features equivalent to those provided above in terms of method.

### BRIEF DESCRIPTION OF THE DRAWINGS

Other features and advantages of the invention will appear more clearly in the light of the following description, made with reference to the accompanying drawings in which:

FIG. 1 represents a device capable of implementing a method according to the invention;

FIG. 2 illustrates the principle of determining priority attributes that are provided by the invention;

FIG. 3 illustrates various possible extractions of data arranged in order in accordance with FIG. 2;

FIG. 4 represents an example of a method of determining priority layers in accordance with the teachings of the invention;

FIG. 5 represents an example of a method of determining priority attributes in accordance with the teachings of the invention;

### DETAILED DESCRIPTION OF PREFERRED EMBODIMENTS

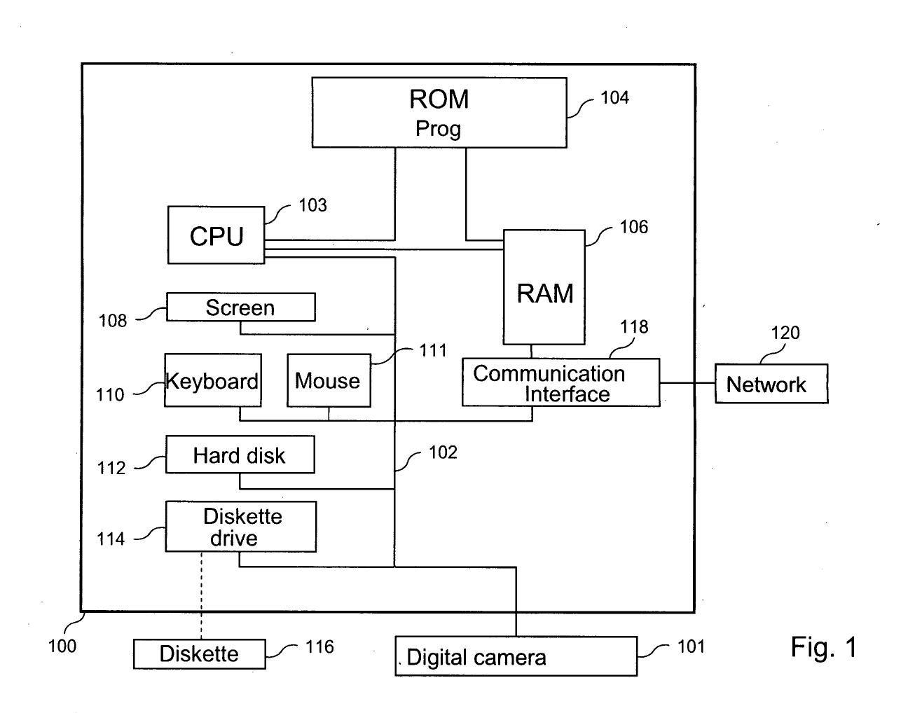

A device which may implement the present invention is illustrated in FIG. 1 in the form of a multimedia unit 100.

The multimedia unit may for example be a microcomputer or a workstation. This device is connected to different peripherals such as any means for image storage connected to a graphics card and supplying multimedia data to device 100.

The device 100 comprises a communication bus 102 to which there are connected:
a microprocessor (or CPU) 103,
a read only memory 104, able to contain one or more programs “Prog” enabling the implementation of the methods in accordance with the invention when that program or those programs are executed by the microprocessor 103,
a random access memory (or RAM) 106, comprising registers adapted to record variables and parameters created and modified during the execution of the aforementioned programs,
a display unit such as a screen 108, for viewing data, or images (for example from a video sequence processed by the invention) and/or serving as a graphical interface in order, in particular, to be able to interact with the programs according to the invention, using a keyboard 110 or any other means such as a pointing device, for example a mouse 111 or an optical stylus,
a digital camera 101 which enables a sequence of images to be taken which it will be possible to code within containers, such as those processed by the invention,
a communication interface 118 connected to a communication network 120, for example the Internet network, the interface being able among others to receive data, in this case, a video stream and in particular, a video stream in SVC format.

The device 100 may also optionally comprise:
a hard disk 112 also able to contain the aforementioned programs “Prog”,
a diskette drive 114 adapted to receive a diskette 116 and to read or write thereon data processed or to be processed, in particular in accordance with the present invention.

The communication bus 102 allows communication and interoperability between the different elements included in the device 100 or connected to it. The representation of the bus is non-limiting and in particular, the microprocessor 103 is able to communicate instructions to any element of the device 100 directly or by means of another element of the device 100.

The executable code of each program enabling the device 100 to implement the methods according to the invention may be stored, for example, on the hard disk 112 or in read only memory 104.

As a variant, the diskette 116 may contain data as well as the executable code of the aforementioned programs which, once read by the device 100, will be stored on the hard disk 112.

In another variant, the executable code of the programs can be received over the communication network 120, via the interface 118, in order to be stored in an identical manner to that described previously.

The diskettes can be replaced by any information carrier such as a compact disc (CD-ROM) or a memory card. Generally, an information storage means, which can be read by a computer or microprocessor, integrated or not into the device 100, and which may possibly be removable, is adapted to store one or several programs whose execution permits the implementation of the methods in accordance with the present invention.

More generally, the program or programs may be loaded into one of the storage means of the device 100 before being executed.

The microprocessor 103 controls and directs the execution of the instructions or portions of software code of the program or programs according to the invention, these instructions being stored on the hard disk 112 or in the read only memory 104 or in the other aforementioned storage elements. On powering up, the program or programs which are stored in a non-volatile memory, for example the hard disk 112 or the read only memory 104, are transferred into the random access memory (RAM) 106, which then contains the executable code of the program or programs according to the invention, as well as registers for storing the variables and parameters necessary for implementation of the invention.

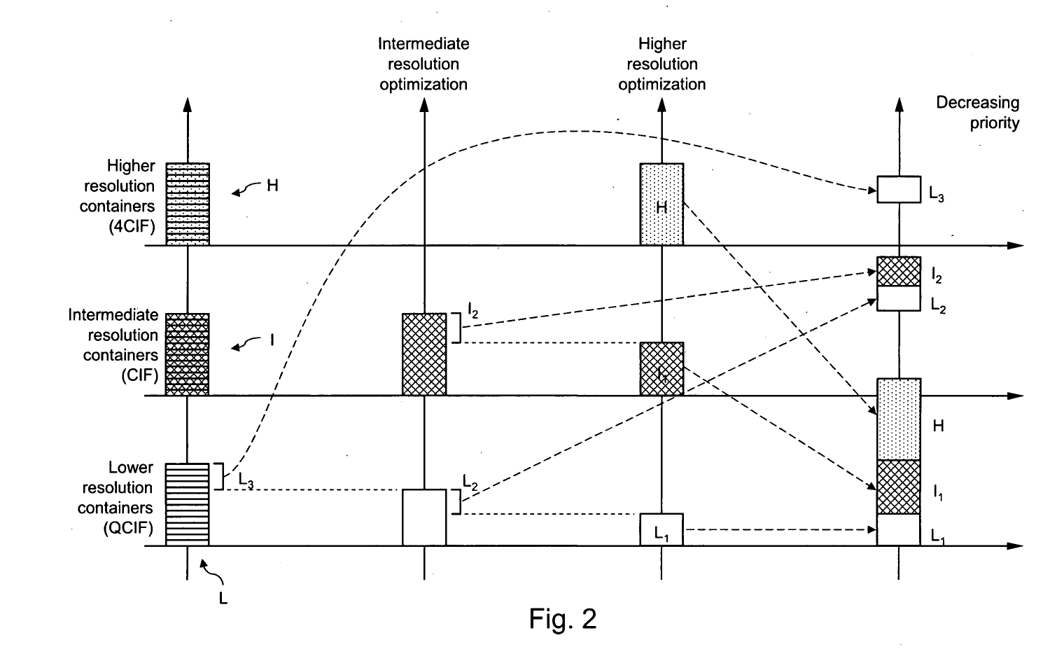

FIG. 2 illustrates the principle of determining priority attributes to allocate to containers for them to be arranged in order, such that it is easy to extract therefrom data representing a video stream optimized in terms of a rate-distortion criterion, this being the case whatever the target resolution level.

In the left part of FIG. 2, three sets of data containers are shown representing, in coded form, a group of pictures respectively with three spatial resolution levels.

More specifically, a first set L of data containers represents, in coded form, a group of pictures at a lower resolution level, here at the resolution level QCIF (i.e. a resolution of 176 pixels by 144 pixels).

The data containers of the set L are moreover arranged in order according to the ability of each of the containers to reduce the distortion for a given rate, the containers giving the greatest reduction in distortion being placed at the bottom of the representation in FIG. 2.

It is to be noted that the forgoing considerations are independent of the type of coding use to represent the group of pictures at the resolution level concerned. There may for example be intra pictures (that is to say coded without reference to another picture) and/or inter pictures (that is to say coded with reference to another picture), possibly with several quality levels for each picture of the group. Indeed, whatever the type of coding used, the data may be placed in containers arranged in order as represented in FIG. 2.

A second set of containers I represents, in coded form, the group of pictures concerned at an intermediate resolution level (here the level CIF, i.e. 352 pixels×288 pixels).

The intermediate spatial resolution level is however coded by reference to the spatial resolution level below (here QCIF) that is to say that, on decoding of the group of pictures, the obtainment of the pictures at the intermediate spatial resolution level CIF on the basis of the data from the containers I requires the prior obtainment of the pictures of the spatial resolution level QCIF below by means of at least a part of the data from the containers L.

Moreover, as for the containers of the set L, the containers of the set I are arranged in order according to their capability to reduce the distortion for a given rate (the containers reducing the distortion the most being placed at the bottom in FIG. 2).

As for the set of containers H, this represents the pictures of the group of pictures at a higher resolution level, here the resolution level 4CIF, that is to say a resolution of 704 pixels by 576 pixels.

As explained previously with regard to the intermediate resolution level, the higher resolution level 4CIF is coded in the data of the containers H by reference to the intermediate resolution level such that the obtainment of the pictures at the higher spatial resolution 4CIF requires the prior obtainment of the picture at the intermediate resolution level and consequently the decoding of at least a part of the data of the containers of the sets I and L.

The containers of the set H are furthermore arranged in order as set forth above with regard to the sets of containers I and L.

The method of determining priority attributes for these different data containers in accordance with the invention comprises two main steps.

The first step consists of successively considering each spatial resolution level and of arranging in order the containers of the resolution level considered so as to consider first those which most reduce the distortion while possibly only selecting a part of the data containers of the lower resolution levels (which have been arranged in order during preceding iterations) so as to optimize a rate-distortion compromise.

Thus, for the lower spatial resolution level, the iteration of the first step relative to that level simply consists of the attribution of respective levels (or attributes) of priority to the containers of the set L.

On the other hand, the iteration relative to the intermediate level comprises selecting a part only of the containers of the set L (containers L₁ and containers L₂ in FIG. 2) which optimizes a rate-distortion compromise on reconstruction of the intermediate resolution level when use is made as reference data of the pictures of the lower spatial resolution level reconstructed only by the data of the containers L₁ and L₂.

This amounts to saying that it is considered that the containers L₃ are less effective in reducing the distortion than an equivalent quantity of the first priority layers of the data of the intermediate resolution level I.

The optimization is made for example by evaluating a rate-distortion criterion on the reconstructed pictures by successively considering a decreasing number of containers of the lower resolution level (that is to say of the set L) taken in the order determined at the preceding iteration. The containers of the set L which do not contribute significantly to the reconstruction quality of the intermediate level then have a minimum priority level (0) attributed to them. These containers, which constitute the set L3 in FIG. 2, are not then considered as advantageous for the intermediate level. The other containers of the lower spatial resolution level form the sets L1 and L2 of FIG. 2 and thus constitute the containers of the lower spatial resolution level selected for the determination of the priority layers of the intermediate spatial resolution level.

According to one variant which may be envisaged, the rate-distortion optimization of the priority levels may be carried out without taking into account the order of the containers determined at the preceding spatial resolution levels. The containers from the lower level (level below) selected for the intermediate level are then in this case arranged in order so as to optimize the rate-distortion criterion for the intermediate spatial resolution level. Only the containers belonging to the set L3 of FIG. 2 will then be kept in the order of the priority levels determined at the iteration relative to the lower spatial resolution level.

The iteration of the step for the intermediate resolution level also comprises arranging in order the different containers such that the first containers most strongly reduce the distortion (as has already been referred to for the lower level).

The first step lastly comprises an iteration relative to the higher resolution level which consists of determining the priority levels (that is to say in practice the priority attributes) of the containers of the set H while optimizing a rate-distortion criterion by selecting a part only of the containers I, L relative to the lower spatial resolution levels, i.e. here relative to the intermediate and lower resolution levels.

The optimization is for example carried out by considering, in each level below the level concerned, a decreasing number of containers as arranged in order in the preceding iterations and by envisaging all the possible combinations. As previously, as a variant it is possible to operate without taking into account the order defined at the iteration relative to the intermediate level.

It is to be noted that consideration is however limited for the lower resolution level QCIF to the containers already selected at the optimization iteration relative to the intermediate resolution level (this being the case whatever the variant envisaged) such that the data containers selected for the present iteration (containers L₁ in FIG. 2) necessarily form part of the containers selected at the preceding iteration (containers L₁+containers L₂ in FIG. 2).

Thus, for each spatial resolution level lower than the resolution level concerned (that is to say here for the intermediate level CIF and lower level QCIF) a selection of containers is obtained (here the containers I₁ of the intermediate resolution level and the containers L₁ of the lower resolution level) which optimize (in terms of a rate-distortion criterion) the reconstruction of the higher resolution level on decoding of the data from the containers H with reference to the selected data I₁ and L₁.

The second step of the method of determining priority attributes consists of combining the results of the iterations of the preceding step as now described and as illustrated on the right in FIG. 2.

The highest priority attributes (designating the containers of highest priority) are allocated (for example by writing a value in a header field of the container) to the data containers L₁, I₁ selected at the iteration included in the first step and relative to the optimization for the higher resolution level 4CIF, as well as to the containers H of the higher spatial resolution level. Because the spatial resolution levels below are used as reference for the resolution levels immediately above, in the set of these containers L₁, I₁, H a higher priority is allocated to the containers L₁ relative to the lower spatial resolution level, then to those I₁ relative to the intermediate spatial resolution level, as can be clearly seen in FIG. 2.

Lastly, in each set of containers L₁, I₁, H relative to a given spatial resolution level, a priority level is attributed in accordance with the order determined at the first step.

A lower priority attribute is allocated to the containers L₂, I₂ selected at the optimization relative to the intermediate spatial resolution level, but not selected at the optimization relative to the higher spatial resolution level. As previously, to the containers L₂ relative to the lower resolution level QCIF, there is allocated a priority attribute higher than to the containers I₂ relative to the intermediate spatial resolution level CIF, and in each set L₂, I₂ relative to a given spatial resolution level, the order determined at the first step is followed.

Lastly, the lowest priority attributes are allocated to the containers L₃ (here relative only to the lowest spatial resolution level QCIF) which have not been selected at the optimization relative to the intermediate spatial resolution level (nor consequently at the optimization relative to the higher spatial resolution level either).

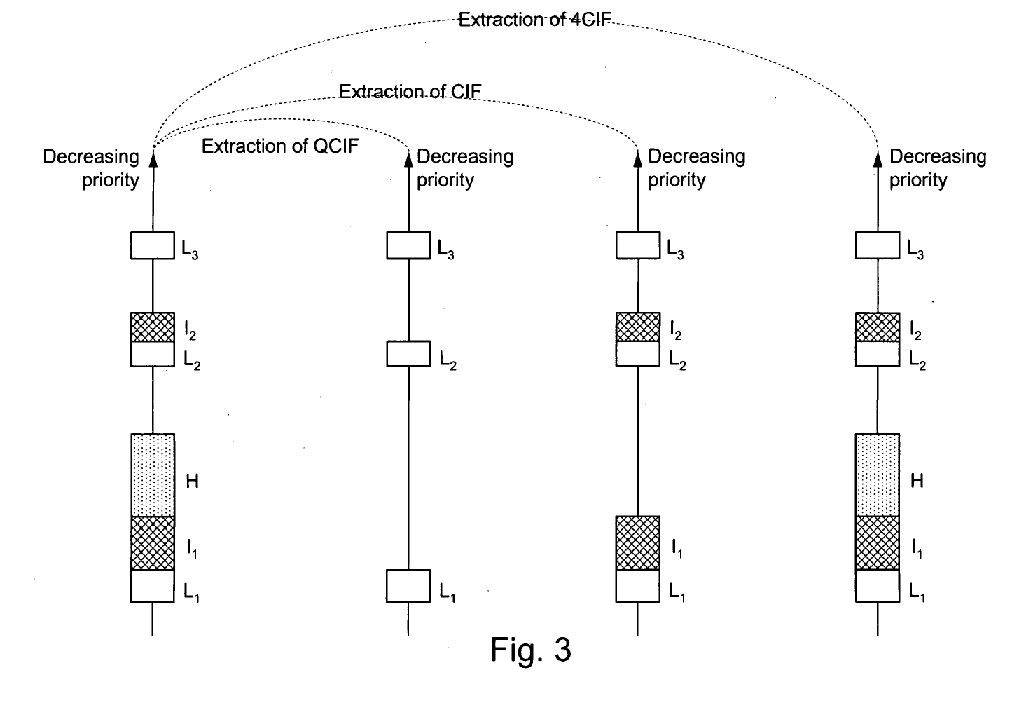

In FIG. 3 the different possibilities are represented for extracting the bitstream after allocation of the priority attributes as has just been described with reference to FIG. 2.

Commencement is thus made with the set of containers that are arranged in order L₁, I₁, H, L₂, I₂, L₃ obtained by means of the method which has just been described.

The priority attribute is for example recorded for this in a header field of the container concerned (for example the field “priority_id” according to the SVC standard). The header may furthermore comprise a field (for example “dependency_id”) which indicates the spatial resolution level which the container concerns.

When it is desired to extract a bitstream for the purpose of representation at the lower spatial resolution level QCIF, consideration is limited to the containers of which the “dependency_id” field indicates that the data that they contain are relative to that lower resolution level QCIF (containers L₁, L₂, L₃). Determination is then made (taking into account the order defined by the priority attributes “priority_id”) of the part of the containers from among those containers L₁, L₂, L₃ which may be transmitted while respecting the available rate, then the bitstream to transmit is constructed on the basis of that part of the determined containers.

It may also be desired to extract the data enabling the reconstruction of the group of pictures at the intermediate spatial resolution level (here CIF).

For this, only the containers are considered that are relative to that intermediate spatial resolution level and relative to the spatial resolution level below (here QCIF), on the basis of the information contained in the field “dependency_id”: consideration is then limited to the containers L₁, I₁, L₂, I₂ and L₃ as can be clearly seen in FIG. 3.

These containers are however arranged in the order which has just been given by virtue of the method described earlier in FIG. 2.

Determination is then made, taking into account the “priority_id” priority attributes, of which part of these containers can be transmitted with the available transmission rate and the bitstream is constructed on the basis of this determined part.

In practice, the bitstream is constructed such that the containers of the different spatial resolution levels are interleaved on transmission (carried out picture by picture): the containers, coming from different spatial resolution levels, serving to decode the same picture are transmitted consecutively, by increasing spatial resolution level.

As the priority attributes of the containers considered here have been attributed by relative optimization specifically at the intermediate spatial resolution level, the extraction so carried out is optimum due to the way it is carried out, in terms of the rate-distortion criterion used at the time of the optimization.

Lastly, it may be desired to extract the data representing the group of pictures at the higher resolution level 4CIF.

For this, all the containers are considered that were arranged in order by the allocation of “priority_id” priority attributes described with reference to FIG. 2: containers L₁, I₁, H, L₂, I₂, L₃.

Determination is than made, while respecting the priority defined by these priority attributes, of the part of the data of the set of the containers capable of being transmitted due to the available rate, and the bitstream is constructed on the basis of that determined part.

The reconstruction will also be optimum here in terms of the rate-distortion criterion used previously since it was precisely for the higher resolution level considered here that the optimization was carried out.

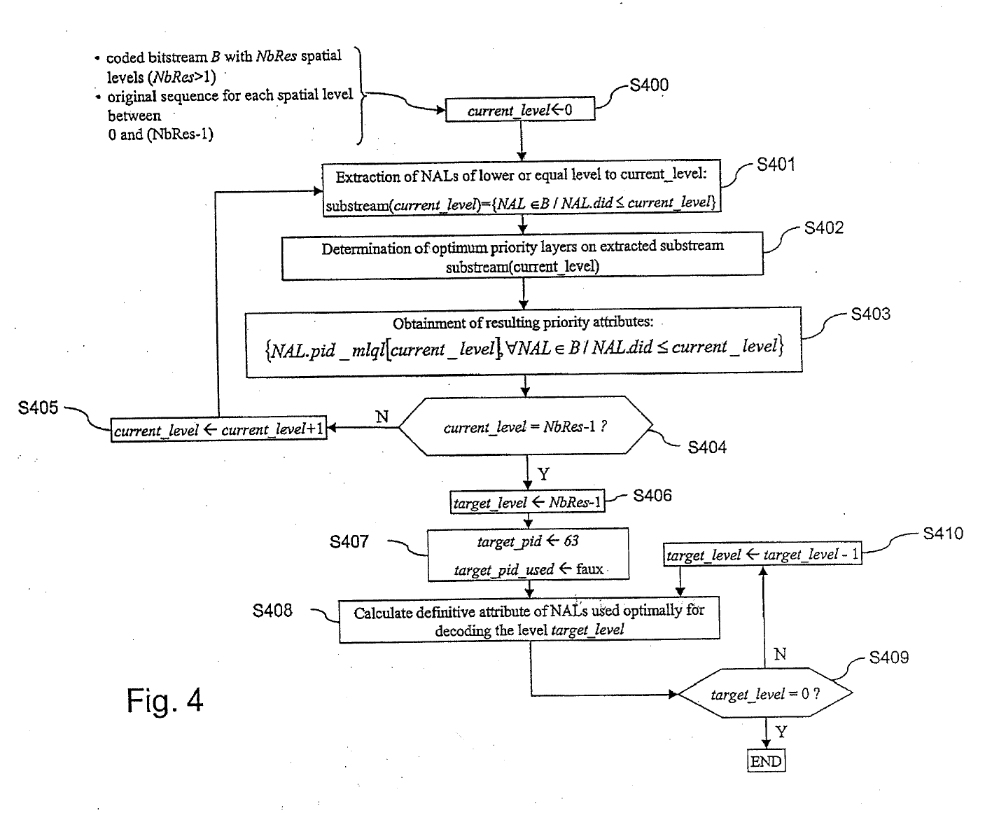

A detailed example is now described, with reference to FIG. 4, of the method of allocating priority attributes in accordance with the general principles which have just been described.

As input this method has available a coded bitstream B at NbRes spatial resolution levels (where NbRes has a value of at least 2; in the example described NbRes has the value 3 but could in general be greater than or equal to 3), as well as the original sequence at each of these spatial resolution levels of the pictures coded in the stream B.

The current level current_level is then initialized at zero (that is to say at the value designating the lowest resolution level) at step S400.

A loop on the current level current_level will then be performed as already explained which will enable each of the spatial resolution levels to be considered successively in order each time to implement an iteration making it possible to determine the priority layers which optimally represent the original sequence for the current level.

Thus step S401 is proceeded to first of all, at which, from the bitstream B, the data containers (designating NAL in FIG. 4 in accordance with the terminology used in the SVC standard) are extracted for which the resolution level is lower than or equal to the current level current_level.

A substream is thus obtained, denoted substream (current_level) in FIG. 4 and which thus comprises, as indicated in that Figure, all the NAL containers of the bitstream B of which the field NAL.did (designating the spatial resolution level) comprises a value less than or equal to the current level current_level.

A method is then applied at step S402 to this extracted substream of determining the order of the different priority layers (sometimes termed quality layers) so as to optimize a rate-distortion compromise by taking into account all the spatial resolution levels of the substream substream (current_level), for example in accordance with what is described in the patent application WO 2007/111460. It is however to be noted that this step applies only to the NAL containers of the spatial resolution layers lower than or equal to the current level current_level, and not to all the spatial resolution levels as proposed in that document (except, of course, when the current level is equal to the highest resolution level).

As already explained with reference to FIG. 2, this method of determining the priority layers, when applied to several spatial resolution levels, gives precedence, rather than to continuing with the definition of the resolution level, to the taking into account (that is to say to the selection) of data of a resolution level immediately above when the data of the level immediately above enable greater reduction of the distortion than continuing the definition of the resolution level immediately below (see for example the containers L₃ which are not taken into consideration—that is to say not selected—when determining the priority layers when considering the resolution levels QCIF and CIF).

The optimization of the rate-distortion compromise is made by comparing the pictures reconstructed by the decoding of the determined priority layers with the pictures of the original sequence referred to above.

A priority attribute is thus obtained at step S403 for each of the NAL containers which was selected at step S402 as enabling the optimum reconstruction of the substream extracted at the current spatial resolution level current_level. The priority attribute so allocated (temporarily) to the NAL containers as a result of step S402 is denoted NAL.pid_mlql [current_level]. In practice and by convention a minimum value (here zero) may be attributed to the field NAL.pid_mlql [current_level] of the NAL containers not selected at step S402 (in order to indicate that these containers have not been selected).

At step S404 it is then verified whether the resolution level which has just been considered is the last level to consider (equal to NbRes−1). In the negative, the current level current_level is incremented at step S405 and step S401 is looped back to.

In the affirmative, the results obtained at the successive iterations of the preceding loop are recombined as illustrated in the right portion of FIG. 2.

For this, to start with, a target level target_level is defined at step S406 equal to the highest spatial resolution level NbRes−1.

Moreover at step S407 a target value is initialized for the priority attribute target_pid at the maximum priority level (here for example 63) and the Boolean value target_pid_used is initialized to false indicating that the current target priority level target_pid has not for the time being been assigned as definitive priority level to any NAL container of the bitstream B.

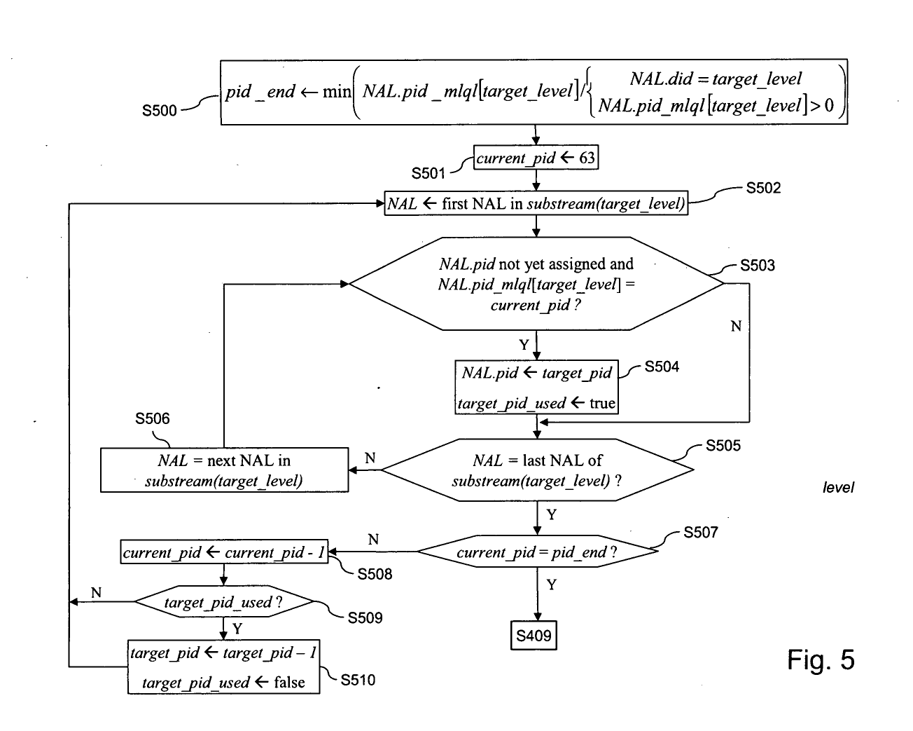

Thus, at step S408 the definitive priority attributes are determined for the NAL containers used in optimum manner for the decoding of the target level target_level as described in detail below with reference to FIG. 5.

Once step S408 has been carried out, step S408 is looped while decrementing the target level target_level (step S410) if the lowest resolution level has not been reached (step S409).

On the other hand, if all the target levels target_level have been gone through, the method is terminated as indicated in FIG. 4.

The loop enabling step S408 to be iterated several times makes it possible, as will be more apparent with the following detailed description of that step, to reorganize the temporary priority attributes determined at step S403 in order for the NAL containers used for the optimum decoding of the higher spatial resolution level to have a higher priority than those which are only optimally used for the decoding of lower spatial resolution levels, while maintaining the order determined at step S402 between the different NAL containers used optimally for the decoding of a given resolution level.

With reference to FIG. 5 the method implemented at step S408 referred to above will now be described.

At step S500 determination is made of the minimum value pid_end taken by the temporary priority attributes NAL.pid_mlql [target_level] allocated at step S402 at the time of the optimization for that target level. As will be seen below, a loop is carried out on the value of the temporary priority attributes between the maximum value (here 63) and this minimum in order to go through all the priority attribute values allocated at the time of this optimization for the target level. In view of the convention adopted above in the present practical implementation, only the temporary priority attributes NAL.pid_mlql [target_level] are taking into account that are strictly greater than 0, so as to consider only the NAL containers which have been selected for the current spatial resolution level.

In order to perform this loop, at step S501 a value of current priority current_pid is initialized to the maximum value for the priority attributes (here 63).

Successive consideration will then be given to all the NAL containers of the substream at that target level substream (target_level).

For this, the process is initialized at step S502 at which the first NAL container of the substream is considered as the current container.

Step S503 is then proceeded to at which it is verified not only that the definitive priority attribute NAL.pid of the current NAL container has not yet been assigned but also whether the temporary priority attribute NAL.pid_mlql [target_level] is equal to the current priority value current_pid.

If these two verifications are positive (which is the case when the NAL container has not been selected for the optimized decoding at the target resolution levels processed previously and when the temporary priority attribute has the current priority value), step S504 is proceeded to at which the definitive priority attribute NAL.pid relative to the current NAL container is set to the target value target_pid, and the Boolean value target_pid_used is set to true, which indicates that the current target priority level target_pid has been attributed to at least one NAL container of the bitstream B.

In the negative, that is to say either that the temporary priority attribute of the current container does not correspond to the current priority level or that the definitive priority attribute NAL.pid has already been allocated (which is the case when the current NAL container is used in the optimum decoding at a resolution level higher than the current target level target_level), step S504 is skipped and step S505 is proceeded to directly.

Step S504 is also followed by step the S505. In all cases this step S505 is thus proceeded to at which it is determined whether the current NAL container is the last container of the substream, in which case at step S507 the loop is left. On the other hand, if all the containers have not been considered, step S506 is proceeded to at which the following container is considered as current container and step S503 is looped to.

At step 507 referred to above, it is verified whether the current priority level current_pid is equal to the minimum pid_end among the possible values (as determined at step S500). In the affirmative, as all the priority values used for the optimum decoding at the level considered target_level have been gone through, step S409 is returned to as already described.

On the other hand, if all the priority levels have not been gone through, step S508 is proceeded to at which the current priority value current_pid is decremented which makes it possible to consider the NAL containers having a priority attribute immediately below.

At step S509 it is then verified whether the current target priority level target_pid has been allocated to at least one NAL container, by evaluating the Boolean value target_pid_used. In the negative, step S502 is returned to directly.

In the affirmative, at step S510, the current target priority level is decremented by one unit and the Boolean value target_pid_used is reset to false. This will make it possible to allocate a definitive value immediately below to the NAL containers having a temporary priority attribute immediately below. Step S502 is then returned to.

As already stated, within the containers used for the optimum decoding of a given resolution level, the order determined at the time of the optimization at that resolution level is kept, while allocating to the NAL containers priority attributes increasing as a function of the highest resolution level for which they have been selected in the step of optimizing the rate-distortion compromise.

The foregoing embodiments are merely possible examples of the implementation of the invention, which is not limited thereto.

1. A method of determining priority attributes respectively associated with a plurality of containers defining at least one image at a plurality of spatial resolution levels, comprising the following steps:
for at least two distinct spatial resolution levels considered, selecting at least one container relative to a level lower than the level considered so as to optimize a rate-distortion criterion obtained by the use, for the decoding of the image at the level considered, of only the containers selected as data relative to said lower level;
associating with each of the selected containers an attribute representing a priority increasing with the maximum level for which the container is selected.

2. A method of determining priority attributes according to claim 1, wherein the selection is carried out within a step comprising the allocation of a temporary priority attribute to each of the containers of the level considered.

3. A method of determining priority attributes according to claim 2, wherein the selection is carried out on the basis of the temporary priority attributes allocated beforehand to the selected containers of the lower level.

4. A method of determining priority attributes according to claim 2, wherein said step comprises the allocation of a temporary priority attribute to each of the selected containers of the lower level.

5. A method of determining priority attributes according to one of claims 2 to 4, wherein the step of associating an attribute with a selected container comprises determining said attribute on the basis of said temporary attribute and of the maximum level for which the container is selected.

6. A method of determining attributes according to one of claims 1 to 4, comprising iterations each corresponding to a spatial resolution level and thus going through the resolution levels in decreasing order, and wherein the associating step is carried out at the first iteration at which the container is selected for the resolution level corresponding to the iteration.

7. A method of determining attributes according to one of claims 1 to 4, wherein the selection for a given spatial resolution level is carried out from the containers selected for the spatial resolution level immediately below said given level.

8. A method of determining attributes according to one of claims 1 to 4, wherein the plurality of containers defines a plurality of images of a video stream.

9. A method of coding at least one image into a data stream comprising a plurality of containers, comprising the following steps:
determining priority attributes associated with said containers according to a method in accordance with one of claims 1 to 4;
writing the determined priority attributes in the data stream.

10. A coding method according to claim 9, wherein the priority attribute associated with a container is written in a header field of said container.

11. A device for determining priority attributes respectively associated with a plurality of containers defining at least one image at a plurality of spatial resolution levels, comprising:
means for selecting, for at least two distinct spatial resolution levels considered, at least one container relative to a level lower than the level considered so as to optimize a rate-distortion criterion obtained by the use, for the decoding of the image at the level considered, of only the containers selected as data relative to said lower level;
means for associating with each of the selected containers an attribute representing a priority increasing with the maximum level for which the container is selected.

12. A device for determining priority attributes according to claim 11, wherein the selecting means are associated with means for allocating a temporary priority attribute to each of the containers of the level considered.

13. A device for determining priority attributes according to claim 12, wherein the means for associating an attribute with a selected container comprise means for determining said attribute on the basis of said temporary attribute and of the maximum level for which the container is selected.

14. A device for determining attributes according to one of claims 11 to 13, wherein the selecting means for a given spatial resolution level are adapted to select said at least one container from the containers selected for the spatial resolution level immediately below said given level

15. A device for determining attributes according to one of claims 11 to 13, wherein the plurality of containers represents a plurality of images of a video stream.

16. A device for coding at least one image into a data stream comprising a plurality of containers, comprising:
a device for determining priority attributes associated with said containers in accordance with one of claims 11 to 13;
means for writing the determined priority attributes in the data stream.

17. A coding device according to claim 16, wherein the writing means are adapted to write the priority attribute associated with a container in a header field of said container.

18. A computer-readable medium having instructions stored therein which when executed by a computer system, causes the computer system to perform the method according to any one of claims 1 to 4.
